(19) United States
(12) Patent Application Publication
(10) Pub. No.: US 2025/0000626 A1
(43) Pub. Date: Jan. 2, 2025

(54) AUTOMATED SPRAY GLAZE

(71) Applicant: Zima International, Inc. d/b/a Dandy, New York, NY (US)

(72) Inventor: Noah Sims, New York, NY (US)

(21) Appl. No.: 18/345,649

(22) Filed: Jun. 30, 2023

(51) Int. Cl. A61C 13/083; C04B 33/24; C04B 33/34

(52) U.S. Cl. CPC A61C 13/083; C04B 33/24; C04B 33/34

(57) ABSTRACT

An apparatus includes a tray configured to hold at least one dental restoration; a lower sprayer configured to spray glaze towards the tray at a first angle; an upper sprayer configured elevated relative to the lower sprayer to spray glaze towards the tray at a second angle, the second angle different than the first angle; and a motor coupled to the tray and configured to rotate the tray at a pre-determined speed.

### BACKGROUND

Conventionally, fixed dental restorations are glazed before being installed in a mouth. This is a manually-intensive process that requires a single user to paint the glaze onto the surface of the restoration by hand with a brush.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

A first aspect of the present disclosure is directed to an apparatus that includes a tray configured to hold at least one dental restoration, a lower sprayer configured to spray glaze towards the tray at a first angle, an upper sprayer configured elevated relative to the lower sprayer to spray glaze towards the tray at a second angle, the second angle different than the first angle, and a motor coupled to the tray and configured to rotate the tray at a pre-determined speed.

A second aspect of the present disclosure is directed to an apparatus that includes a tray having a first restoration holder and a second restoration holder, the first restoration holder having a first dental restoration and the second restoration holder having a second dental restoration, a sprayer configured to project a spray towards the tray, and a motor coupled to the tray and configured to rotate the tray between at least a first position and a second position. In this aspect, the first dental restoration is within the spray in the first position, and the second dental restoration is within the spray in the second position.

A third aspect of the present disclosure is directed to an apparatus that includes a tray configured to hold at least one dental restoration, a first sprayer configured to spray glaze towards the tray at a first angle, a second sprayer configured to spray glaze towards the tray at a second angle, the second angle different than the first angle, and a reservoir storing glaze, the reservoir in fluid communication with both the first sprayer and the second sprayer, such that each of the first sprayer and the second sprayer spray a same glaze.

### BRIEF DESCRIPTION OF THE DRAWINGS

FIG. 1 is a perspective view of a glaze sprayer.

FIG. 2 is a rear perspective view of the glaze sprayer of FIG. 1.

FIG. 3A is a left view of the glaze sprayer of FIG. 1.

FIG. 3B is a left view of a bracket of the glaze sprayer of FIG. 1.

FIG. 3C is a left view of a spraying unit of the glaze sprayer of FIG. 1.

FIG. 4 is a perspective view of the glaze sprayer of FIG. 1 with spray.

FIG. 5 is a perspective view of a glaze spray system that includes the glaze sprayer of FIG. 1.

FIG. 6 is a detailed view of the glaze spray system of FIG. 5.

FIG. 7 is a top view of the glaze spray system of FIG. 5.

FIG. 8 is a top view of the glaze spray system of FIG. 5 with spray.

FIG. 9 is a bottom view of the glaze spray system of FIG. 5.

FIG. 10A is a detailed view of a tray of the glaze spray system of FIG. 5 with spray.

FIG. 10B is a detailed view of the tray of FIG. 10A without spray.

FIG. 11 is a perspective view of the system of FIG. 5 in a housing.

FIG. 12 is a perspective view of the system of FIG. 11 with a door hidden for clarity.

### DETAILED DESCRIPTION

Reference will now be made in detail to various embodiments, examples of which are illustrated in the accompanying drawings. While this disclosure includes certain embodiments, it will be understood the disclosure is not intended to limit the claims to these embodiments. On the contrary, the disclosure is intended to cover alternatives, modifications and equivalents, which may be included within the spirit and scope of the claims. Furthermore, in this detailed description, numerous specific details are set forth in order to provide a thorough understanding. However, one of ordinary skill in the art will appreciate that the subject matter of the present disclosure may be practiced without these specific details. In other instances, well known methods, procedures, and components have not been described in detail as not to unnecessarily obscure aspects of the present disclosure.

Various embodiments of this disclosure include a system for autonomously applying glaze to dental restoration by aerosolizing the glaze and utilizing multiple sprayers at different angles relative to the target restoration. Some embodiments of the system include four sprayers positioned about a central tray. Three of the sprayers are spaced (e.g., evenly) about a circumference of the central tray and are relatively level with the target restorations, which are held by the central tray. The fourth sprayer is suspended from above and oriented downwards in order to apply glaze spray to a relative top of the target restorations. Once the sprayers are engaged (e.g., spraying glaze), the central tray rotates at a set speed in order to expose each target restoration on the tray to the sprays of glaze. The four sprayers may be oriented such that an area of overlap formed by the convergence of all four sprays is over a single restoration position on the central tray. By then rotating the central tray, each restoration may take a turn in the area of overlap. In some embodiments, each of the four sprayers is connected to a glaze reservoir and an air reservoir, with the glaze and air mixed within the sprayer to aerosolize the glaze. Notably, the four sprayers may be connected to the same reservoir, as each sprayer may provide the same type and/or composition of glaze. Properties of the glaze spray (e.g., cone width, density, volume, intensity, etc.) may be controlled by adjusting an amount of glaze and/or air being input into each sprayer.

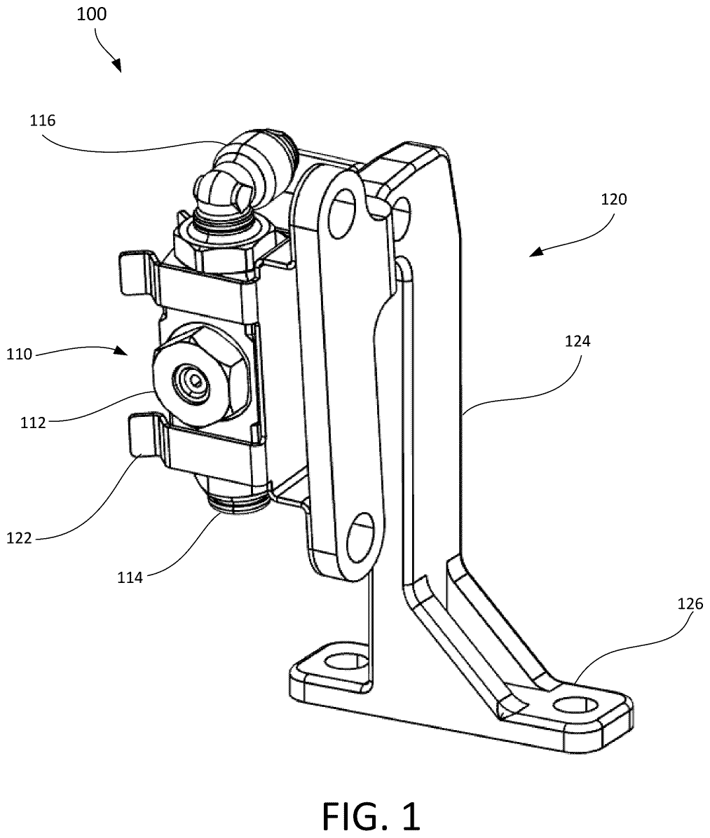

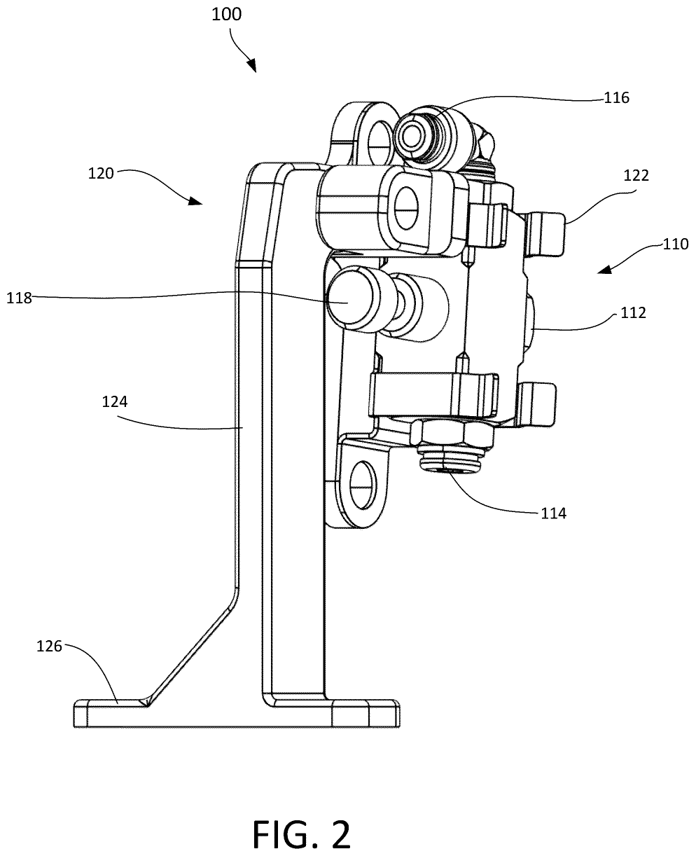

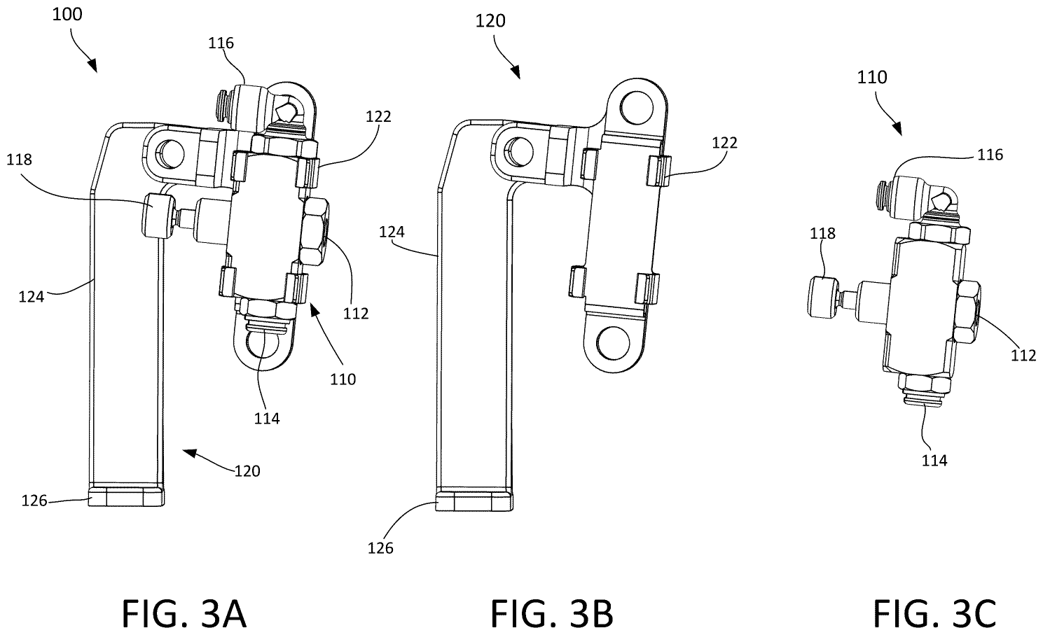

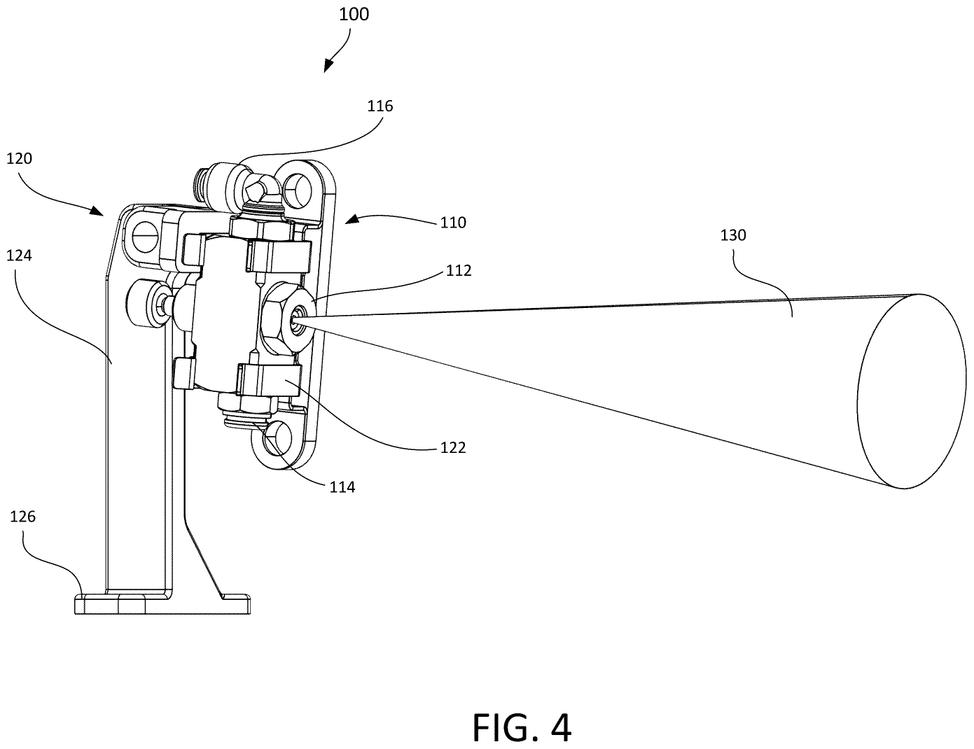

FIGS. 1-4 illustrate an example sprayer 100 for applying aerosolized glaze to ceramic dental restorations. As shown, the sprayer 100 may include a spraying unit 110 and a bracket 120. The spraying unit 110 may include a nozzle 112, a first inlet 114, a second inlet 116, and a control knob 118. Each of the first inlet 114 and the second inlet 116 may be configured to couple to a respective fluid tube (not shown). In some embodiments, the first inlet 114 may be for receiving liquid glaze, as the orientation of the first inlet 114 relative to a coupled fluid tube would encourage (e.g., due to gravity) any unused liquid glaze to drain back into the fluid tube rather than remaining in the spaying unit. The control knob 118 may control an amount of liquid glaze that enters the spraying unit 110 by controlling a size of an opening in the first inlet. The control knob 118 may affect only the liquid glaze, and may not affect the flow of air into the spraying unit 110. The liquid glaze may be a suspension of powdered glaze and isopropyl alcohol (e.g., 99% pure isopropyl alcohol). In one example, the liquid glaze may be 20-30% powdered glaze (and ideally 25%) and 70-80% (and ideally 75%) isopropyl alcohol, by weight.

The second inlet 116, correspondingly, may be for receiving compressed air. The compressed air and the liquid glaze may commingle in an inner chamber of the spraying unit 110, with the compressed air causing the liquid glaze to aerosolize and/or atomize. The flow of compressed air may be controlled or adjusted externally from the spraying unit 110. For example, the flow of compressed air may be controlled at the source of the air (e.g., via an air pressure regulator), and may be set at a substantially-fixed value (e.g., 35 psi). The force of this commingling may create a pressure vacuum, which propels the aerosolized glaze out through an available opening—the nozzle 112. The nozzle 112 may have an opening of a fixed size, such that the spread of a resultant spray 130 is relatively fixed. In some embodiments, the nozzle 112 opening may have a variable size, and may be controlled directly on the spraying unit 110 and/or in response to commands from an external controller. The spray 130 may be substantially-conical, but may be any suitable shape based on a corresponding shape of the nozzle 112.

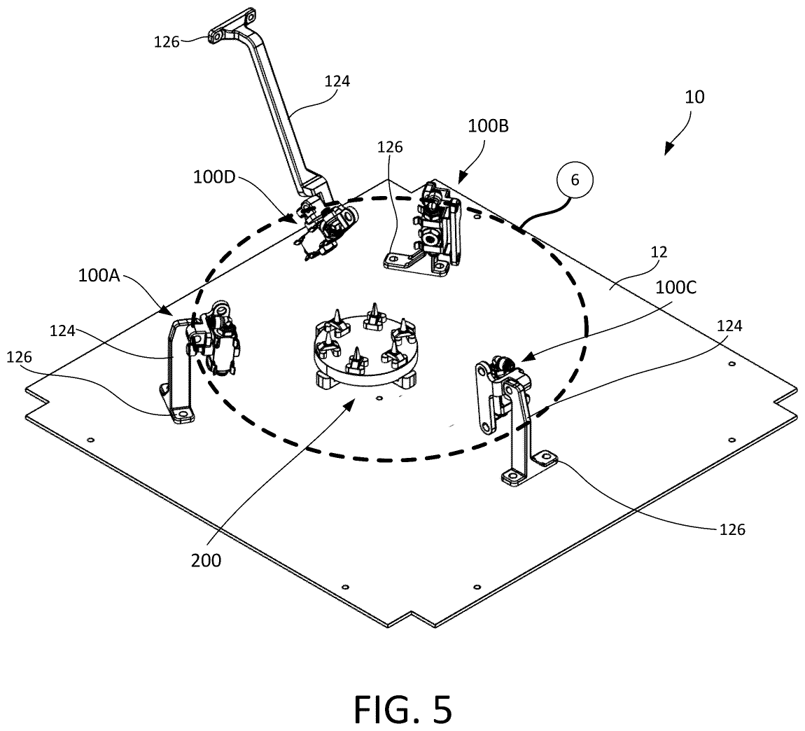

As shown, the bracket 120 may include a clip 122, a stem 124, and a mount 126. The clip 122 may be configured to secure the spraying unit 110 to the bracket 120. In the example shown, the clip 122 includes two sets of extensions configured to fit about the spraying unit 110. Accordingly, the inside of each extension may mirror the exterior of the spraying unit 110 in order to facilitate a snug fit. The mount 126 may provide a flat base for the bracket 120, and may include at least two apertures for receiving fasteners. The stem 124 may extend from the clip 122 to the mount 126, and may be of a pre-determined length in order to distance the spraying unit 110 from a surface 12 to which the mount 126 is attached. The connection between the stem 124 and the clip 122 may enable rotation of the clip 122 relative to the stem 124 in order to control an angle of the spraying unit 110 relative to the mounting surface 12. With reference to FIG. 5, the stem 124 may be of different lengths, shapes, and angles in order to accommodate the particular sprayer 100. As shown in FIG. 5, for example, the stem 124 for an upper sprayer (e.g., fourth sprayer 100D) is much longer and more slanted than stem 124 for a lower sprayer (e.g., first sprayer 100A). In addition, an angle of the fourth sprayer 100D may be much steeper (e.g., −38°) relative to a plane defined by the surface 12 than that of the lower sprayers (e.g., −5.5°). For example, the angle of the fourth sprayer may be −30°, −31°, −32°, −33°, −34°, −35°, −36°, −37°, −38°, −39°, and −40°, and the angle of the lower sprayers may be 0°, −1°, −2°, −3°, −4°, −5°, −6°, −7°, −8°, −9°, and −10°.

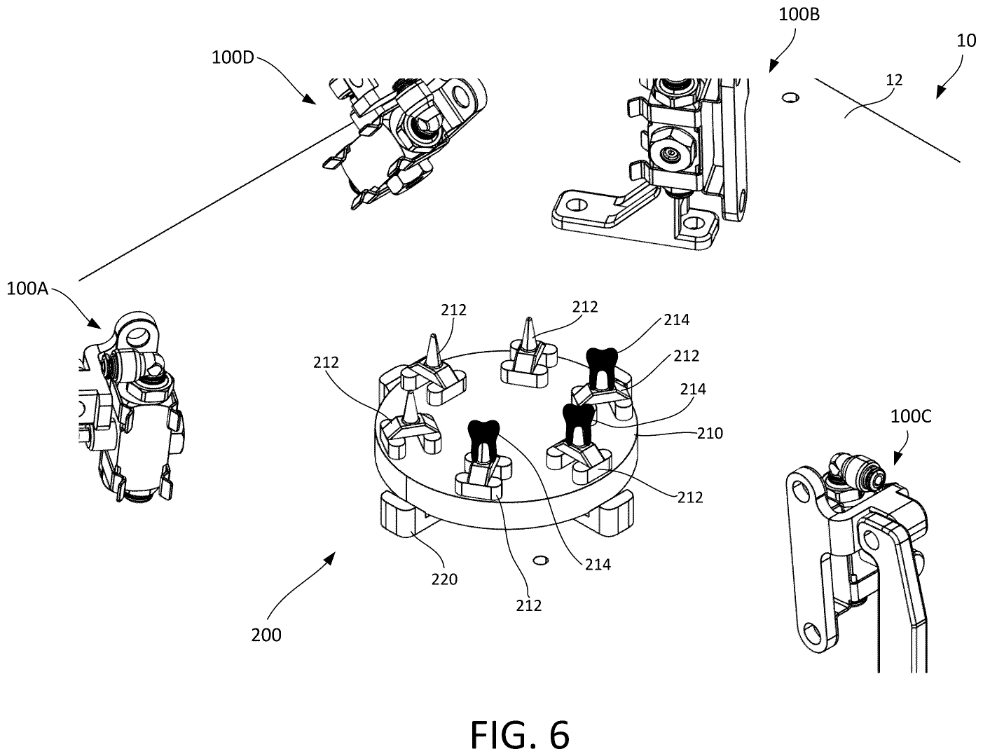

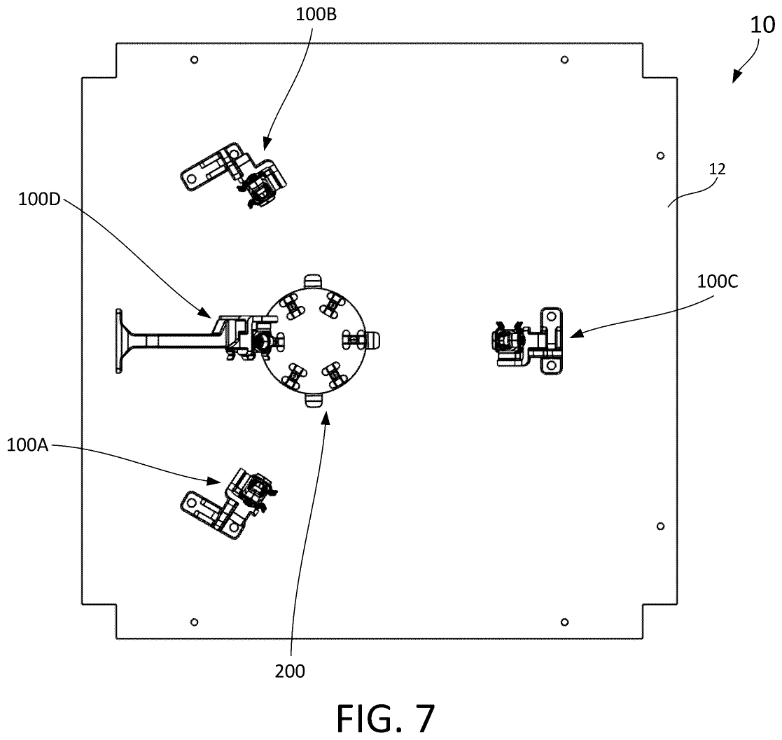

Referring now to FIGS. 5-12, an example spray system 10 that includes multiple sprayers 100 is shown. Although the embodiment shown includes four sprayers 100—a first sprayer 100A, a second sprayer 100B, a third sprayer 100C, and a fourth sprayer 100D—this disclosure should not be read as limited to only those systems for spraying glaze that include four sprayers. Rather, this disclosure should be read as applicable to spray systems with other numbers of sprayers, as well as for spray systems with different orientations for their included sprayers, provided that the number of sprayers and their relative positions permit complete and uniform glazing of the restoration.

In the embodiment shown, first sprayer 100A, second sprayer 100B, and third sprayer 100C are mounted to a relative floor (e.g., the surface 12, etc.) of the system 10, with fourth sprayer 100D mounted in an elevated position (e.g., to a wall, ceiling, roof, frame, etc.). In one example, the nozzle 112 of each of the lower sprayers is 55-60 mm (ideally 59.5 mm) above the surface 12 and 130-140 mm (ideally 136 mm) from a center of a tray 200, and the nozzle 112 of the fourth sprayer 100D is elevated 90-110 mm (and ideally 100 mm) above the surface 12 and 35-45 mm (ideally 41 mm) from the center of the tray 200. An angle of the spray 130 may be defined by the spraying unit 110 and the shape of the nozzle 112, and may be independent of characteristics of the glaze or air. In one example, the angle of the spray may be between 12-16° (and ideally) 14.6°.

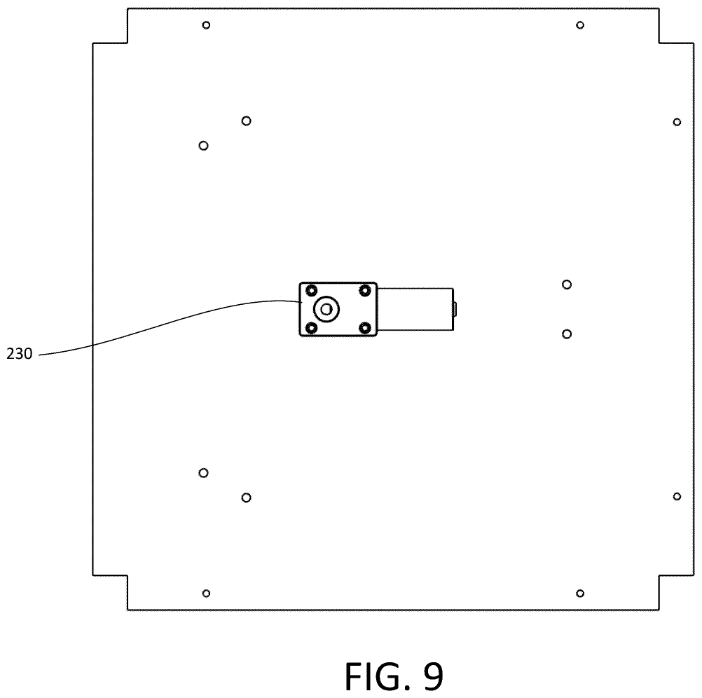

The tray 200 may include a tray base 210 upon which at least one restoration holder 212 may rest, where each restoration holder 212 is configured to receive and hold an restoration 214, and a tray holder 220 configured to elevate the tray base 210 (e.g., 20 mm relative to the surface 12 of the system 10) and, in some embodiments, rotate the tray base 210. For example, the tray holder 220 may be mechanically coupled to a motor 230 (shown in FIG. 9) that may be mounted on an underneath of the mounting surface 12. In one example, the motor 230 may cause the tray base 210 to rotate at a speed between 8-12 rpm (ideally 10 rpm), to accommodate 3 full rotations of the tray 200 during an 18-second cycle. By rotating the tray base 210, the motor 230 enables multiple restorations (e.g., batches) to be glazed in the same cycle, rather than having to swap out individual restorations for each cycle.

The tray base 210 may be any suitable tray (e.g., 80 mm firing tray) for dental restorations, and may be dental porcelain furnace fire-safe. For example, the tray base 210 used within the system 10 may be a same tray base upon which the dental restorations 214 may be initially furnace-fired prior to glazing. Similarly, the restoration holders 212 may be porcelain furnace fire-safe. In some embodiments, the restoration holders 212 may be fixed to the tray base 210. In some embodiments, the tray base 210 may have slots, orifices, depressions, or similar features for receiving restoration holders 212, such that the restoration holders 212 are not fixed to the tray base 210 but are in pre-determined positions. In some embodiments, the restoration holders 212 are set onto the tray base 210 without a guide.

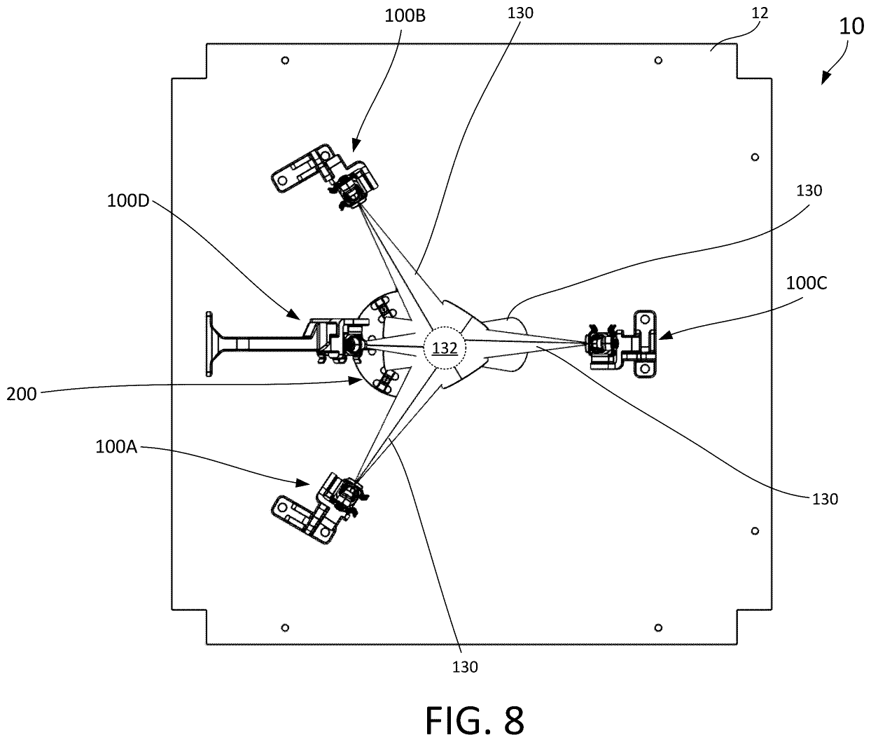

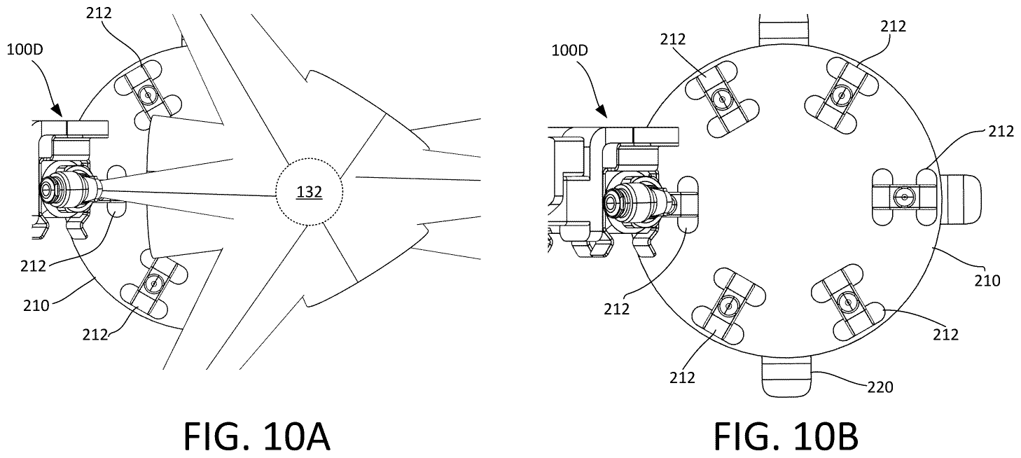

Referring now to FIG. 8, when all four of the sprayers 100 are engaged, their respective sprays 130 form an overlap area 132, defined as the 3-dimensional space that is simultaneously affected by all four sprays 130. Shown best in FIGS. 10A-B, the sprayers 100 are configured such that the overlap area 132 is positioned near to an edge of the tray 200, such that a restoration positioned near to the edge of the tray 200 will be fully within the overlap area 132. In an example in which the tray 200 is a standard 80 mm firing tray, the overlap area 132 may be centered at 35 mm from a center of the tray 200. Although the overlap area 132 is defined as the area affected by all four sprayers 100 at a same time, restorations 214 may be introduced to at least one spray 130 at multiple positions and/or times throughout a glazing cycle. As illustrated in FIG. 8, the spray 130 from the second sprayer 100B includes at least two restoration holders 212, as does the spray 130 from the first sprayer 100A. Accordingly, each restoration 214 may be sprayed at different angles by the first, second, and third sprayers 100A-C as the restoration holders 212 travel along an arcuate path (defined by the rotation of the tray base 210).

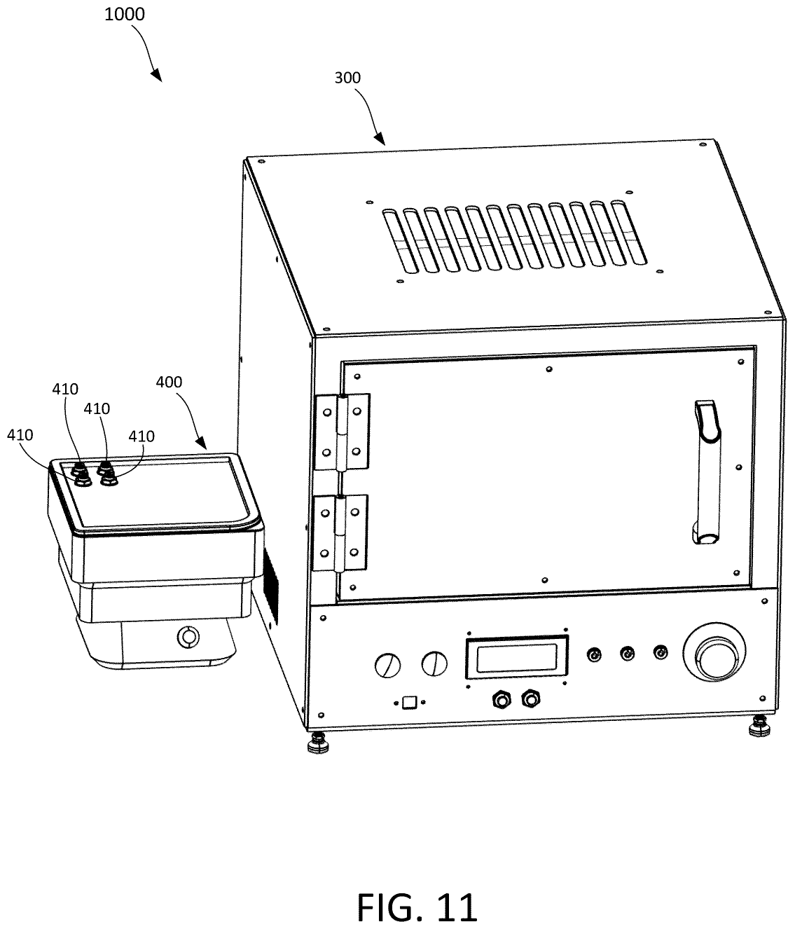

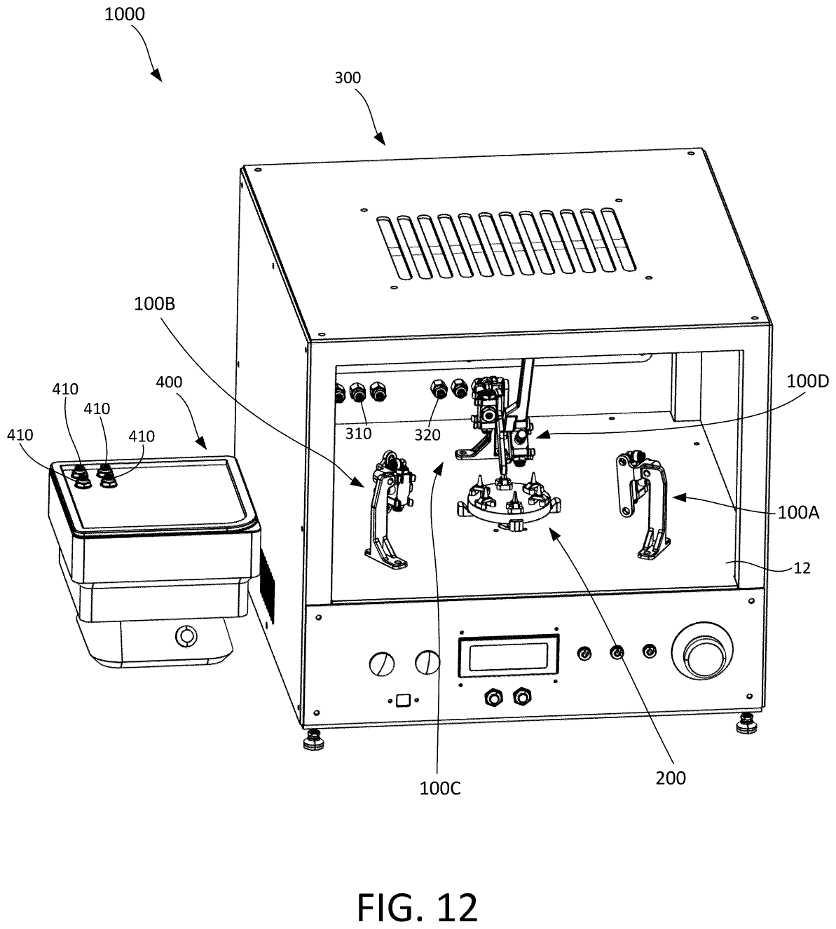

As shown in FIGS. 11-12. the system 10 may be contained within an external housing 300 that may include one or more first inlets 310 and one or more second inlets 320, which may connect to a respective first inlet 114 and a respective second inlet 116 of a respective sprayer 100, with each sprayer 100 connected to its own pair of first inlet 310 and second inlet 320. Accordingly, the first inlets 310 may themselves be connected to glaze reservoir 400 and, particularly, glaze outlets 410. The second inlets 320 may be connected to an external air tank (not shown). The glaze reservoir 400 may be a container with magnetic stirrer or other object within the reservoir 400 that moves within the reservoir 400. Because the glaze powder is suspended in the alcohol solution within the reservoir 400, it is advantageous that the liquid glaze is continuously stirred (or otherwise agitated) in order to maintain this suspended state.

A system or method for glazing dental restoration s according to the embodiments described herein possesses several advantages over previous systems. By utilizing a substantially automated process, various embodiments remove many of the human elements from the glazing process, which improves the speed of the process as well as its consistency. The aerosolized nature of the glaze also enables the system 10 to glaze multiple restoration s in a same cycle, as the spray of glaze from a single sprayer may apply glaze to more than one restoration at the same time, in contrast to a handheld brush. The capacity of the system 10 to accommodate batch-glazing is further enhanced by the rotation of the tray on which the restorations are positioned, as the rotating tray—in concert with the fixed positions of the sprayers—ensures that all necessary faces of the restorations are exposed to aerosolized glaze. Batch-glazing using the system 10 described herein also improves throughput, as multiple restorations are glazed in the same cycle, which is already a shorter cycle than existing hand-painting processes.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus comprising:
a tray configured to hold at least one dental restoration;
a lower sprayer configured to spray glaze towards the tray at a first angle;
an upper sprayer configured elevated relative to the lower sprayer to spray glaze towards the tray at a second angle, the second angle different than the first angle; and
a motor coupled to the tray and configured to rotate the tray at a pre-determined speed.

2. The apparatus of claim 1, wherein the lower sprayer comprises three lower sprayers.

3. The apparatus of claim 2, wherein the three lower sprayers are equally-spaced radially about the tray.

4. The apparatus of claim 1, wherein the first angle is between 0 and −10°, and the second angle is between −30° and −40°.

5. The apparatus of claim 1, wherein the at least one dental restoration comprises two or more dental restorations.

6. The apparatus of claim 1, wherein respective sprays from the lower sprayer and the upper sprayer overlap to spray a same dental restoration at a same time.

7. The apparatus of claim 1, wherein the tray is a same tray used to introduce the at least one dental restoration into a dental porcelain furnace.

8. An apparatus comprising:
a tray having a first restoration holder and a second restoration holder, the first restoration holder having a first dental restoration and the second restoration holder having a second dental restoration;
a sprayer configured to project a spray towards the tray; and
a motor coupled to the tray and configured to rotate the tray between at least a first position and a second position,
wherein:
in the first position, the first dental restoration is within the spray, and
in the second position, the second dental restoration is within the spray.

9. The apparatus of claim 8, wherein the motor is configured to continue the rotation from the second position to the first position in a same direction as from the first position to the second position.

10. The apparatus of claim 8, wherein the sprayer comprises a lower sprayer configured to project a first spray towards the tray at a first angle and an upper sprayer configured elevated relative to the lower sprayer to project a second spray towards the tray at a second angle, the second angle different than the first angle.

11. The apparatus of claim 10, wherein the lower sprayer comprises three lower sprayers that are equally-spaced radially about the tray.

12. The apparatus of claim 10, wherein the first angle is between 0 and −10°, and the second angle is between −30° and −40°.

13. The apparatus of claim 8, wherein the tray is a same tray used to introduce the at least one dental restoration into a dental porcelain furnace.

14. An apparatus comprising:
a tray configured to hold at least one dental restoration;
a first sprayer configured to spray glaze towards the tray at a first angle;
a second sprayer configured to spray glaze towards the tray at a second angle, the second angle different than the first angle; and
a reservoir storing glaze, the reservoir in fluid communication with both the first sprayer and the second sprayer, such that each of the first sprayer and the second sprayer spray a same glaze.

15. The apparatus of claim 14, further comprising:
an air tank in communication with both the first sprayer and the second sprayer.

16. The apparatus of claim 14, wherein respective sprays from the lower sprayer and the upper sprayer overlap to spray a same dental restoration at a same time.

17. The apparatus of claim 14, wherein the lower sprayer comprises three lower sprayers.

18. The apparatus of claim 18, wherein the three lower sprayers are equally-spaced radially about the tray.

19. The apparatus of claim 14, wherein the tray is a same tray used to introduce the at least one dental restoration into a kiln.

20. The apparatus of claim 14, further comprising a motor coupled to the tray and configured to rotate the tray at a pre-determined speed.
